(19) United States
(12) Patent Application Publication
(10) Pub. No.: US 2016/0011708 A1
(43) Pub. Date: Jan. 14, 2016

(54) MULTI-AXIS INPUT DEVICE AND MULTI-AXIS INPUT APPARATUS

(71) Applicant: Samsung Electro-Mechanics Co., Ltd., Suwon-Si (KR)

(72) Inventor: Il Kwon CHUNG, Gyeonggi-do (KR)

(73) Assignee: Samsung Electro-Mechanics Co., Ltd., Suwon-Si (KR)

(21) Appl. No.: 14/676,963

(22) Filed: Apr. 2, 2015

(30) Foreign Application Priority Data
Jul. 14, 2014 (KR) 10-2014-0088279

(51) Int. Cl. G06F 3/041; G06F 3/044

(52) U.S. Cl. CPC G06F 3/0414; G06F 3/044; G06F 2203/04104; G06F 2203/04106

(57) ABSTRACT

There is provided a multi-axis input device including an elastic layer deformed depending on a direction of force applied from the outside; an upper electrode pattern formed on the top of the elastic layer; and a lower electrode pattern formed on the bottom of the elastic layer, and each of the upper electrode pattern and the lower electrode pattern includes a plurality of electrodes, and each of the plurality of electrodes includes a surface electrode, and a line electrode electrically connected to the surface electrode and disposed around the surface electrode, thereby simultaneously detecting a location touched by a finger, or the like, pressed pressure at the touch location, and shear force (twisting).

### CROSS-REFERENCE TO RELATED APPLICATION

This application claims the benefit of Korean Patent Application No. 10-2014-0088279, filed on Jul. 14, 2014, entitled “Multi-axis Input Device and Multi-axis Input Apparatus” which is hereby incorporated by reference in its entirety into this application.

### BACKGROUND

The present disclosure relates to a multi-axis input device and a multi-axis input apparatus.

In most cellular phones and mobile apparatuses, a touch screen is used. The touch screen is an intuitive user interface (UI) that controls the apparatus by directly touching a finger on a display. However, when the touch screen is used, the necessity of a multi-axis touch sensor is increased for recognition of a touch location by a touch and addition of a pressure sensing function at the time of controlling the apparatus by contacting an icon or a key on a screen.

Further, the necessity of the multi-axis touch sensor is increased in order to implement various user interfaces even in an input key of a TV remote controller, a switch, a portable joystick, a skin for an input device covered on handles of a vehicle and a motor cycle, or a grip sensor for sporting goods, which senses an input of a user in addition to the touch screen.

A patent document disclosed in the related art document described below relates to a capacitive touch screen to simultaneously recognize the touch location and the magnitude of force pressed by the touch and relates to a capacitive touch screen to locate a transparent elastic layer between a plurality of upper transparent electrodes and a plurality of lower transparent electrodes and determine force (pressure) pressed by a stylus (alternatively, the finger) based on the magnitude of a capacitance value, and a driving method thereof.

### RELATED ART DOCUMENT

### Patent Document

(Patent Document 1) KR10-2011-0087153 A

### SUMMARY

An aspect of the present disclosure may provide a multi-axis input device that can sense a contact location, applied pressure, and twisting (shear force).

Another aspect of the present disclosure may provide a multi-axis input apparatus that can sense a contact location, applied pressure, and twisting (shear force).

According to an aspect of the present disclosure, a multi-axis input device may include: an elastic layer deformed depending on a direction of force applied from the outside; and an upper electrode pattern and a lower electrode pattern formed on respective surfaces of the elastic layer, respectively. Each of the upper electrode pattern and the lower electrode pattern may include a plurality of electrodes including a surface electrode and a line electrode disposed around the surface electrode.

According to another aspect of the present disclosure, a multi-axis input apparatus may include: the multi-axis input device as described above; a driving unit applying a driving signal to one electrode pattern of the multi-axis input device; a sensing unit receiving a signal output from the other electrode pattern of the multi-axis input device; and a control unit deciding a touch location, applied pressure, or shear force based on the output of the sensing unit.

When user's touch occurs or force in a predetermined direction is applied, the elastic layer may be deformed horizontally (x-axis direction) or vertically (y-axis direction) based on the surface of the elastic layer according to the direction of the applied force or deformed in a direction (z-axis direction) vertical to the surface of the elastic layer and the elastic layer is restored to an original shape when the applied force disappears.

When an external object touches the electrode, a value of capacitance between the surface electrode of the upper electrode pattern and the surface electrode of the lower electrode pattern corresponding thereto or a value of capacitance between the line electrode of the upper electrode pattern and the line electrode of the lower electrode pattern corresponding thereto may vary to sense the touch location and when the force in the predetermined direction is applied to the electrode, the value of the capacitance between the surface electrode and the surface electrode corresponding thereto while the elastic layer is deformed in the direction of the applied force varies to sense the amount of the applied pressure, and the value of the capacitance between the line electrode and the line electrode corresponding thereto may vary to sense the amount of the shear force (twisting).

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram showing a structure of a multi-axis input device according to an exemplary embodiment of the present disclosure;

FIG. 2A is a diagram showing an upper electrode pattern;

FIG. 2B is a diagram showing a lower electrode pattern;

FIG. 3A is a diagram showing an array of the upper electrode pattern and the lower electrode pattern of the multi-axis input device of FIG. 1 viewed from the top when an elastic layer is transparent;

FIG. 3B is a cross-sectional view for describing the array of the upper electrode pattern and the lower electrode pattern of the multi-axis input device shown in FIG. 3A taken along line AA′;

FIG. 3C is a diagram showing the size of an exemplary electrode, and the sizes and intervals of a surface electrode and a line electrode;

FIGS. 4A and 4B are diagrams for describing a touch location sensing operation principle of the multi-axis input device according to the exemplary embodiment of the present disclosure;

FIG. 5 is a diagram for describing a pressure sensing operation principle of the multi-axis input device according to the exemplary embodiment of the present disclosure;

FIG. 6 is a diagram for describing a shear force (twisting) sensing operation principle of the multi-axis input device according to the exemplary embodiment of the present disclosure;

FIG. 7 is a block diagram of the multi-axis input apparatus according to the exemplary embodiment of the present disclosure; and

FIG. 8 is a flowchart for describing a shear force (twisting) sensing operation of a multi-axis input apparatus according to an exemplary embodiment of the present disclosure.

### DETAILED DESCRIPTION

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present disclosure, when it is determined that the detailed description of the related art would obscure the gist of the present disclosure, the description thereof will be omitted.

Hereinafter, exemplary embodiments of the present disclosure will be described in detail with reference to the accompanying drawings.

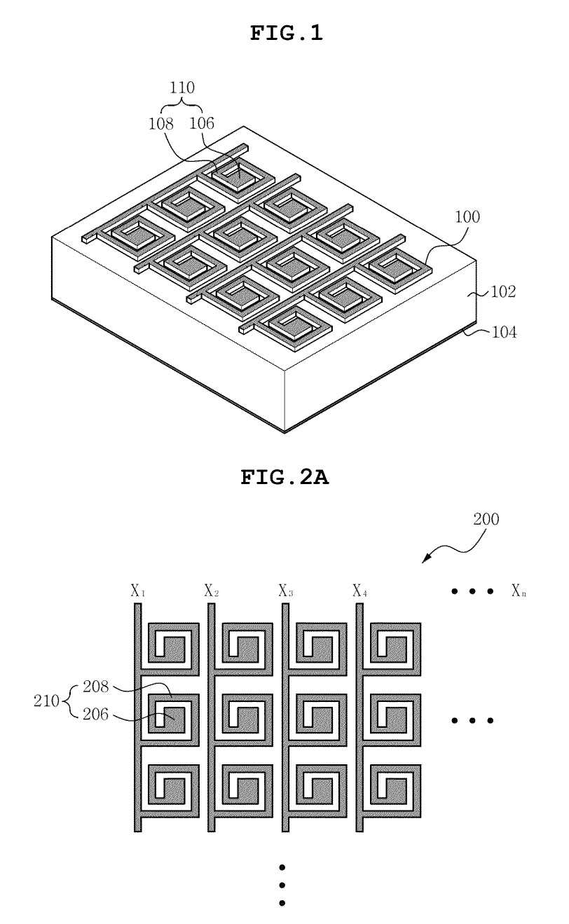

FIG. 1 is a diagram showing a structure of a multi-axis input device according to an exemplary embodiment of the present disclosure.

The multi-axis input device according to the exemplary embodiment of the present disclosure shown in FIG. 1 includes an elastic layer 102 deformed according to a direction of force applied from the outside, an upper electrode pattern 100 formed on the top of the elastic layer 102, and a lower electrode pattern 104 formed on the bottom of the elastic layer 102.

The upper electrode pattern 100 includes a plurality of electrodes 110, and each of the plurality of electrodes 110 includes a surface electrode 106 and a line electrode 108 disposed around the surface electrode 106.

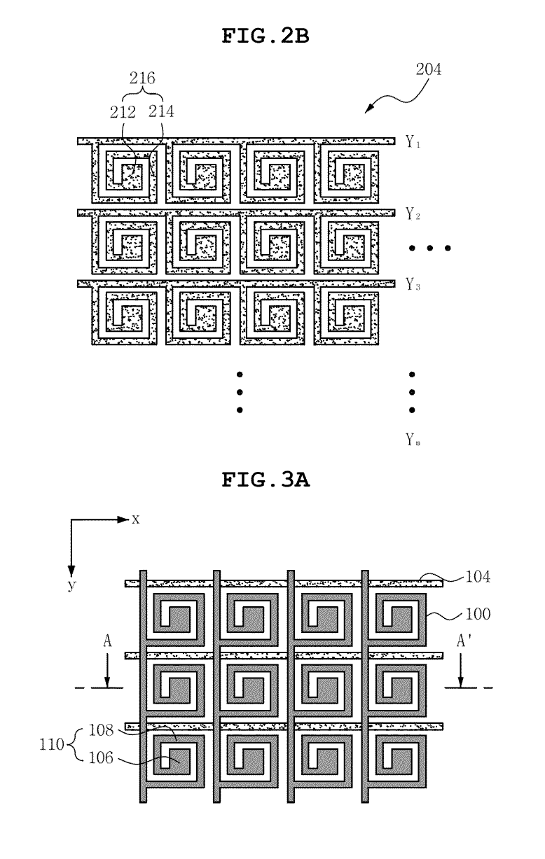

A structure of the lower electrode pattern 104 of FIG. 1 is the same as that of a lower electrode pattern 204 of FIG. 2B and referring to FIG. 2B, the lower electrode pattern 204 includes a plurality of electrodes 216 and each of the plurality of electrodes 216 includes a surface electrode 212 and a line electrode 214 disposed around the surface electrode 212.

In FIG. 1, it is shown that a total of 12 electrodes of four in a horizontal direction and three in a vertical direction are formed on each of the top and the bottom of the elastic layer 102 for easy description, but the number of the electrodes is not limited thereto and as shown in FIGS. 2A and 2B, electrodes more than 12 electrodes may be formed on each surface of the elastic layer 102.

Referring to an upper electrode pattern 200 shown in FIG. 2A, n electrodes are formed in the horizontal direction and referring to the lower electrode pattern 204 shown in FIG. 2B, m electrodes are formed in the vertical direction.

Since the upper electrode pattern 200 shown in FIG. 2A and the lower electrode pattern 204 shown in FIG. 2B correspond to each other, each of the upper electrode pattern 200 shown in FIG. 2A and the lower electrode pattern 204 shown in FIG. 2B includes n electrodes in the horizontal direction and m electrodes in the vertical direction, that is, n×m electrodes. In the above description, n and m are positive integers.

In the exemplary embodiment of the present disclosure, the upper electrode pattern 200 including electrode lines X1, X2, X3, . . . , Xn which become an x coordinate for sensing the touch location is formed on the top of the elastic layer 102 and the lower electrode pattern 204 including electrode lines Y1, Y2, Y3, . . . , Ym which become a y coordinate for sensing the touch location is formed on the bottom of the elastic layer 102, but the exemplary embodiment of the present disclosure is not limited thereto and the upper electrode pattern 200 may be formed on the bottom of the elastic layer 102 and the lower electrode pattern 204 may be formed on the top of the elastic layer 102.

The elastic layer 102 is deformed horizontally (x-axis direction) or vertically (y-axis direction) based on the surface of the elastic layer 102 according to the direction of the applied force or deformed in a direction (z-axis direction) vertical to the surface of the elastic layer 102 and the elastic layer 102 is restored to an original shape when the applied force disappears.

In the exemplary embodiment of the present disclosure, the elastic layer 102 may be an elastic polymer, but the exemplary embodiment of the present disclosure is not limited thereto.

The elastic polymer may include thermoplastic elastomer (TPE) and the TPE may include one of a group consisting of thermoplastic styrene (TPS), thermoplastic olefin (TPO), thermoplastic vinyl chloride (TPVC), thermoplastic urethane (TPU), and thermoplastic amide (TPA).

Further, in the exemplary embodiment of the present disclosure, the elastic layer 102, the upper electrode pattern 100, and the lower electrode pattern 104 may be made of a transparent material or an opaque material.

The multi-axis input device according to the exemplary embodiment of the present disclosure is a device that may simultaneously sense three physical quantities of touch location sensing, applied pressure sensing, and shear force (twisting) sensing.

Due to shapes of the upper electrode patterns 100 and 200 and the lower electrode patterns 104 and 204 shown in FIGS. 1 to 3B and a structure in which the elastic layer 102 is sandwiched between the upper electrode patterns 100 and 200 and the lower electrode patterns 104 and 204, all of three physical quantities may be sensed.

First, the upper electrode pattern 200 will be described. The upper electrode pattern 200 shown in FIG. 2A is first constituted by electrode lines X1, X2, X3, . . . , Xn which become the x coordinate for sensing the touch location.

The number of electrode lines is decided by considering a whole area and location sensing resolution of the device. In addition, a plurality of electrodes 210 that serve as sensors are disposed for the respective electrode lines X1, X2, X3, . . . , Xn. The number of the sensors of the respective electrode lines X1, X2, X3, . . . , Xn is also decided by considering the whole area and the location sensing resolution of the device.

In the exemplary embodiment of the present disclosure, each electrode 210 serving as the sensor includes a surface electrode 206 and a line electrode 208 electrically connected to the surface electrode 206. Further, in the exemplary embodiment of the present disclosure, the electrode 210 is formed in a spiral structure in which the line electrode 208 surrounds the surface electrode 206, but the exemplary embodiment of the present disclosure is not limited thereto and any form of electrode structure may also be used, in which the surface electrode is disposed at the center and the line electrode is disposed around the surface electrode.

In addition, in the exemplary embodiment of the present disclosure, the shape of the surface electrode 206 is a quadrangular shape, but may be formed even by any type of 2D or 3D figure including a predetermined dimension, such as any type of polygonal shape such as a triangular shape, a pentagonal shape, a hexagonal shape, and the like or circular and oval shapes in addition to the quadrangular shape.

Further, the size and the width, and an interval of each electrode 210 serving as the sensor are also decided by considering various performances.

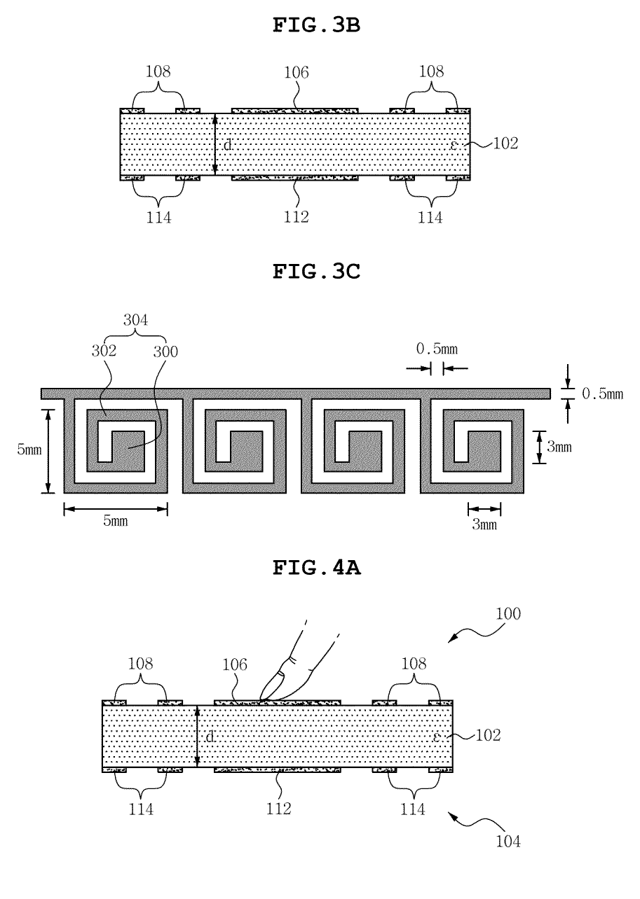

For example, as shown in FIG. 3C, in the exemplary embodiment of the present disclosure, the size of an electrode 304 has approximately 5 mm wide and approximately 5 mm long, the size of a surface electrode 300 has approximately 3 mm wide and approximately 3 mm long, and the width of a line electrode 302 is approximately 0.5 mm, and the interval of the electrode may be approximately 0.5 mm, but the exemplary embodiment of the present disclosure is not limited thereto and electrodes having various sizes and various intervals may be used.

FIG. 2B is a diagram showing the lower electrode pattern 204. The lower electrode pattern 204 is primarily substantially the same as the upper electrode pattern 200 in terms of the shape, the size, and the interval. However, since the lower electrode pattern 204 senses a y-axis coordinate for sensing the location unlike the upper electrode pattern 200, the lower electrode pattern 204 is different from the upper electrode pattern 200 only in that the electrode line are twisted from the electrode line of the upper electrode pattern 200 in terms of direction by 90°.

The lower electrode pattern 204 shown in FIG. 2B is first constituted by electrode lines Y1, Y2, Y3, . . . , Ym which become the y coordinate for sensing the touch location.

The number of electrode lines is decided by considering the whole area and the location sensing resolution of the device. In addition, a plurality of electrodes 216 that serve as sensors are disposed for the respective electrode lines Y1, Y2, Y3, . . . , Ym. The number of the sensors of the respective electrode lines Y1, Y2, Y3, . . . , Ym is also decided by considering the whole area and the location sensing resolution of the device.

In addition, each electrode 216 serving as the sensor includes a surface electrode 212 and a line electrode 214. The each electrode 216 is formed in the spiral structure in which the line electrode 214 surrounds the surface electrode 212, but the exemplary embodiment of the present disclosure is not limited thereto and any electrode structure may also be used, in which the surface electrode is disposed at the center and the line electrode is disposed around the surface electrode.

Further, the size and the width, and an interval of each electrode 216 serving as the sensor are decided by considering various performances.

For example, as shown in FIG. 3C, the size of an electrode 304 has approximately 5 mm wide and approximately 5 mm long, the size of a surface electrode 300 has approximately 3 mm wide and approximately 3 mm long, and the width of a line electrode 302 is approximately 0.5 mm, and the interval of the electrode may be approximately 0.5 mm, but the exemplary embodiment of the present disclosure is not limited thereto and electrodes having various sizes and various intervals may be used.

The upper electrode pattern 200 and the lower electrode pattern 204 are formed on the top and the bottom of the elastic layer 102, respectively as shown in FIGS. 1 and 3B.

The thickness of the elastic layer 102 may be dozens of pm to hundreds of μm by considering measurement sensitivity and user's feeling.

Further, the locations or the arrays of the upper electrode pattern 100 and the lower electrode pattern 104 need to accurately match each other as shown in FIGS. 3A and 3B.

As shown in FIGS. 3A and 3B, the line electrodes 108 of the upper electrode pattern 100 and the line electrodes 114 of the lower electrode pattern 104 corresponding thereto are disposed at locations which correspond to each other, that is, substantially the same location on the top and the bottom of the elastic layer 102.

Further, as shown in FIG. 3B, the surface electrodes 106 of the upper electrode pattern 100 and the surface electrodes 112 of the lower electrode pattern 104 corresponding thereto are disposed at locations which correspond to each other, that is, substantially the same location on the top and the bottom of the elastic layer 102.

An operation of the multi-axis input device according to the exemplary embodiment of the present disclosure configured as above will be described below.

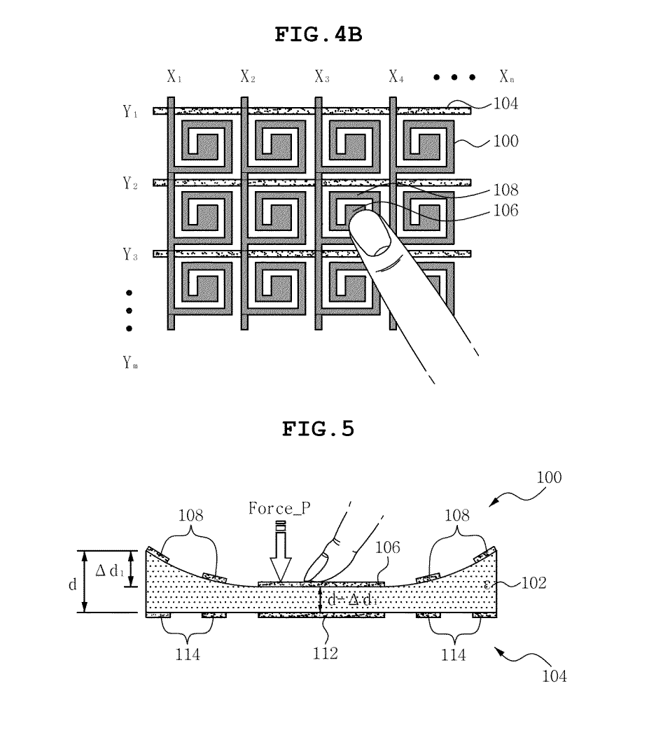

FIGS. 4A and 4B are diagrams for describing a touch location sensing operation principle of the multi-axis input device according to the exemplary embodiment of the present disclosure.

As shown in FIG. 4B, voltage is applied to the lower electrode pattern 104 and voltage is sensed in the upper electrode pattern 100. When the voltage is applied to the lower electrode pattern 104, the voltage is not simultaneously applied to the electrode lines Y1, Y2, Y3, . . . , Ym of the lower electrode pattern 104 and the voltage is sequentially applied to the electrode lines Y1, Y2, Y3, . . . , Ym as if scanning all of the electrode lines Y1, Y2, Y3, . . . , Ym of the lower electrode pattern 104. That is, the voltage is sequentially applied as if performing scanning with a time difference.

When no object touches the surface of the device, a capacitance generated by the elastic layer 102 which is a dielectric between the upper electrode pattern 100 and the lower electrode pattern 104 is constant.

However, as shown in FIGS. 4A and 4B, when a finger or other objects touch the surface of the upper electrode pattern 100, the capacitance instantaneously varies at a touch location on matrix of the upper electrode pattern 100 and the lower electrode pattern 104.

An x coordinate and a y coordinate (X3, Y2) at a point where the capacitance varies on the matrix are extracted to sense the touch location.

FIG. 5 is a diagram for describing a pressure sensing operation principle of the multi-axis input device according to the exemplary embodiment of the present disclosure.

As shown in FIG. 5, when pressure is applied at the touch location, contraction occurs due to a feature of the elastic layer 102 and an interval between the upper electrode pattern 100 and the lower electrode pattern 104 decreases as large as the elastic layer 102 contracts (Δd1). That is, when the pressure is applied at the touch location, an interval between the surface electrode 106 of the upper electrode pattern 100 and the surface electrode 112 of the lower electrode pattern 104 decreases from d to d-Δd1.

When the interval between the upper electrode pattern 100 and the lower electrode pattern 104 decreases, the capacitance increases. The variation of the capacitance is measured to sense the amount of the applied pressure.

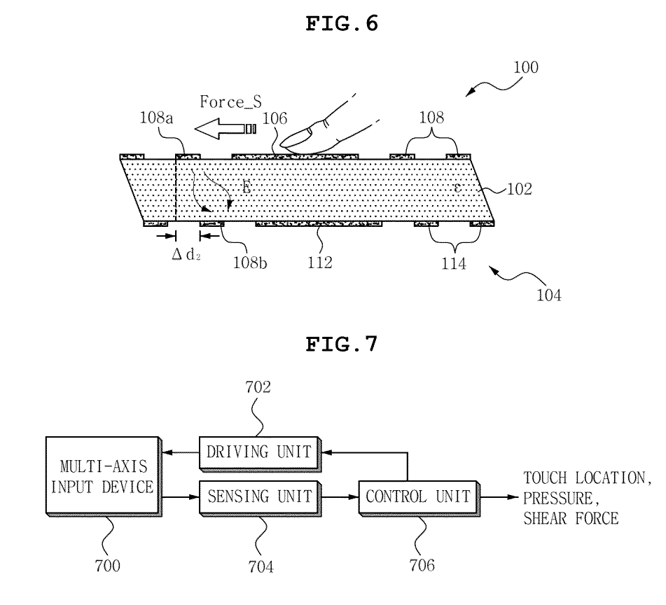

FIG. 6 is a diagram for describing a shear force (twisting) sensing operation principle of the multi-axis input device according to the exemplary embodiment of the present disclosure.

As shown in FIG. 6, when force (shear force) is applied at the touch location in a horizontal direction, deformation occurs to the side due to the feature of the elastic layer 102 and arrays of the upper electrode pattern 100 and the lower electrode pattern 104 are spaced apart from each other by Δd2. In this case, an electric field between a line electrode 108a of the upper electrode pattern 100 and a line electrode 108b of the lower electrode pattern 104 decreases, and as a result, the capacitance decreases. The variation of the capacitance is measured to sense the amount of the shear force (twisting).

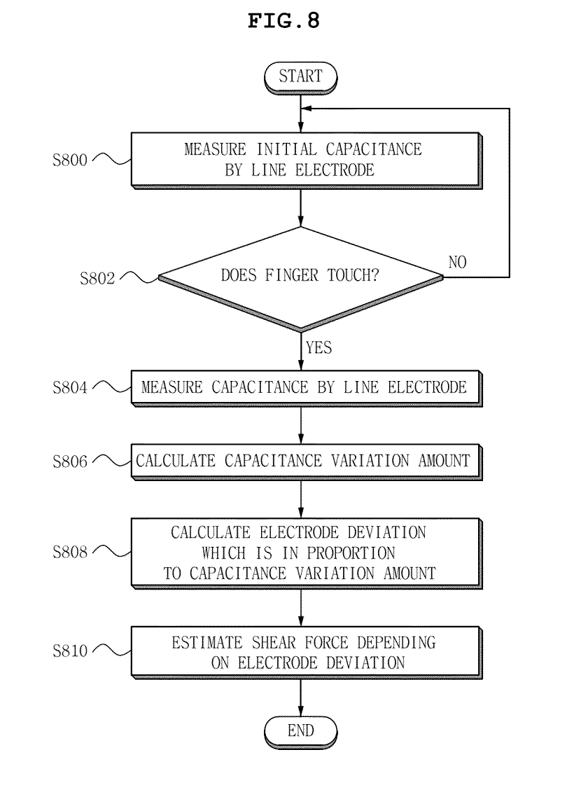

FIG. 7 is a block diagram of the multi-axis input apparatus according to the exemplary embodiment of the present disclosure. FIG. 8 is a flowchart for describing a shear force (twisting) sensing operation of a multi-axis input apparatus according to an exemplary embodiment of the present disclosure.

Hereinafter, the multi-axis input apparatus according to the exemplary embodiment of the present disclosure will be described with reference to FIGS. 7 and 8.

FIG. 7 is a diagram showing the multi-axis input apparatus including the multi-axis input device according to the exemplary embodiment of the present disclosure.

The multi-axis input apparatus according to the exemplary embodiment of the present disclosure shown in FIG. 7 includes a multi-axis input device 700 for sensing a touch location, applied pressure, or shear force, a driving unit 702 for applying a driving signal to a lower electrode pattern which is a driving electrode of the multi-axis input device 700, a sensing unit 704 receiving a signal output from an upper electrode pattern which is a sensing electrode of the multi-axis input device 700, and a control unit 706 deciding the touch location, the applied pressure, or the shear force based on the output signal of the upper electrode pattern.

The multi-axis input device 700 includes an elastic layer 102 deformed according to a direction of force applied from the outside, lower electrode patterns 104 and 204 as the driving electrode formed on the bottom of the elastic layer 102, and upper electrode patterns 100 and 200 as the sensing electrode formed on the top of the elastic layer 102, as shown in FIGS. 1, 2A, and 2B.

Referring to FIG. 2A, the upper electrode pattern 200 includes a plurality of electrodes 210, and each of the plurality of electrodes 210 includes a surface electrode 206 and a line electrode 208 disposed around the surface electrode 206.

Referring to FIG. 2B, the lower electrode pattern 204 includes a plurality of electrodes 216, and each of the plurality of electrodes 216 includes a surface electrode 212 and a line electrode 214 disposed around the surface electrode 212.

Referring to FIGS. 4A, 4B, 5, and 7, when a finger or other objects touch the surface of the upper electrode pattern 100 of the multi-axis input device 700 or when the pressure is applied to the touch location, the capacitance instantaneously varies at the touch locations on matrix of the upper electrode pattern 100 and the lower electrode pattern 104 and the control unit 706 extracts an x coordinate and a y coordinate (X3, Y2) at a point where the capacitance varies on the matrix of the upper electrode pattern 100 and the lower electrode pattern 104 based on a signal received from the sensing unit 704 to decide the touch location or the amount of the applied pressure.

Further, referring to FIGS. 6 and 7, when the finger or other objects touch the surface of the upper electrode pattern 100 of the multi-axis input device 700 and the force (shear force) is applied to the touch location in a horizontal direction, deformation occurs to the side due to a feature of the elastic layer 102 and the capacitance between the upper electrode pattern 100 and the lower electrode pattern 104 decreases. The control unit 706 decides the amount of the shear force (twisting) based on the variation of the capacitance.

Referring to FIGS. 6 and 8, a method for deciding the shear force will be described in detail.

In step S800, the control unit 706 measures initial capacitance by the line electrodes 108a and 108b, that is, capacitance.

In step S802, the control unit 706 determines whether the finger touches the upper electrode pattern 100.

When it is determined that the finger touches the upper electrode pattern 100 in step S802, the control unit 706 measures the capacitance by the line electrodes 108a and 108b, that is, the capacitance again.

In step S806, the control unit 706 calculates a variation amount of the capacitance by the line electrodes 108a and 108b, that is, a difference between the initial capacitance and capacitance after the touch.

In step S808, the control unit 706 calculates a deviation Δd2 between the line electrodes 108a and 108b that is in proportion to the variation amount of the capacitance.

In step S810, the control unit 706 measures the shear force (twisting) based on the deviation Δd2 between the line electrodes 108a and 108b.

As described above, the control unit 706 calculates the deviation Δd2 between the two line electrodes 108a and 108b based on a difference between the initial capacitance between the line electrode 108a of the upper electrode pattern 100 and the line electrode 108b of the lower electrode pattern 104 and capacitance between two line electrodes 108a and 108b after predetermined force is applied to the elastic layer 102 and estimates the shear force depending on the calculated deviation Δd2 between the two line electrodes 108a and 108b.

According to the exemplary embodiment of the present disclosure, when the touch occurs or the pressure is applied by implementing the electrode patterns on the top and the bottom of the elastic layer 102 and when the shear force is applied in a predetermined direction, the variation amount of the capacitance is measured on multi-axes to simultaneously sense three physical quantities of the touch location (x, y axis) and pressed pressure (z axis), and the shear force.

As described above, according to the exemplary embodiment of the present disclosure, the touch location of the finger, and the like, the pressed pressure at the touch location, and the shear force (twisting) may be simultaneously sensed.

Further, according to the exemplary embodiment of the present disclosure, since the multi-axis input device may be fabricated in a form of a polymer film in which the electrode is formed in a specific pattern, the multi-axis input device may be thin.

According to the exemplary embodiment of the present disclosure, when the elastic layer and the electrode patterns are made of a transparent material, the multi-axis input device may be applied to a touch screen of an electronic apparatus.

According to the exemplary embodiment of the present disclosure, the multi-axis input device and apparatus may be applied to a skin for an input device covered on a smart phone case and a new user interface may be implemented by using the same.

According to the exemplary embodiment of the present disclosure, the multi-axis input device and apparatus may be applied to implement various user interfaces such as a direction key of a TV remote controller, a switch, a portable joystick, a skin for an input device covered on handles of a vehicle and a motor cycle, or a grip sensor for sporting goods.

Although the exemplary embodiment of the present disclosure has been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to be within the scope of the disclosure, and the detailed scope of the disclosure will be disclosed by the accompanying claims.

What is claimed is:

1. A multi-axis input device comprising:
an elastic layer deformed depending on a direction of force applied from the outside;
an upper electrode pattern formed on the top of the elastic layer; and
a lower electrode pattern formed on the bottom of the elastic layer,
wherein each of the upper electrode pattern and the lower electrode pattern includes a plurality of electrodes, and
each of the plurality of electrodes includes
a surface electrode, and
a line electrode electrically connected to the surface electrode and disposed around the surface electrode.

2. The multi-axis input device of claim 1, wherein the line electrodes of the upper electrode pattern and the line electrodes of the lower electrode pattern corresponding thereto are disposed at locations corresponding to each other on the top and the bottom of the elastic layer.

3. The multi-axis input device of claim 2, wherein the surface electrodes of the upper electrode pattern and the surface electrodes of the lower electrode pattern corresponding thereto are disposed at the locations corresponding to each other on the top and the bottom of the elastic layer.

4. The multi-axis input device of claim 3, wherein the shapes, the sizes, and the intervals of the plurality of electrodes of the upper electrode pattern are substantially the same as the shapes, the sizes, and the intervals of the plurality of electrodes of the lower electrode pattern, respectively.

5. The multi-axis input device of claim 1, wherein each of the plurality of electrodes of the upper electrode pattern and the plurality of electrodes of the lower electrode pattern are formed in a structure in which the line electrode surrounds the surface electrode.

6. The multi-axis input device of claim 5, wherein each of the plurality of electrodes of the upper electrode pattern and the plurality of electrodes of the lower electrode pattern are formed in a spiral structure in which the line electrode surrounds the surface electrode.

7. The multi-axis input device of claim 1, wherein the elastic layer is deformed horizontally (an x-axis direction) or vertically (a y-axis direction) based on the surface of the elastic layer in accordance with the direction of the applied force or deformed in a direction (a z-axis direction) vertical to the surface of the elastic layer.

8. The multi-axis input device of claim 7, wherein the elastic layer is deformed in accordance with the direction of the applied force and restored to an original shape when the applied force disappears.

9. The multi-axis input device of claim 8, wherein the elastic layer includes an elastic polymer.

10. The multi-axis input device of claim 9, wherein:
the elastic polymer includes thermoplastic elastomer (TPE), and
the thermoplastic elastomer includes one of a group consisting of thermoplastic styrene (TPS), thermoplastic olefin (TPO), thermoplastic vinyl chloride (TPVC), thermoplastic urethane (TPU), and thermoplastic amide (TPA).

11. A multi-axis input apparatus comprising:
a multi-axis input device including an elastic layer deformed depending on a direction of force applied from the outside, an upper electrode pattern formed on the top of the elastic layer, and a lower electrode pattern formed on the bottom of the elastic layer, wherein each of the upper electrode pattern and the lower electrode pattern includes a plurality of electrodes, and each of the plurality of electrodes includes a surface electrode, and a line electrode electrically connected to the surface electrode and disposed around the surface electrode;
a driving unit applying a driving signal to the lower electrode pattern of the multi-axis input device;
a sensing unit receiving a signal output from the upper electrode pattern of the multi-axis input device; and
a control unit deciding a touch location, applied pressure, or shear force based on an output of the sensing unit.

12. The multi-axis input apparatus of claim 11, wherein the line electrodes of the upper electrode pattern and the line electrodes of the lower electrode pattern corresponding thereto are disposed at locations corresponding to each other on the top and the bottom of the elastic layer.

13. The multi-axis input apparatus of claim 12, wherein the surface electrodes of the upper electrode pattern and the surface electrodes of the lower electrode pattern corresponding thereto are disposed at the locations corresponding to each other on the top and the bottom of the elastic layer.

14. The multi-axis input apparatus of claim 13, wherein the shapes, the sizes, and the intervals of the plurality of electrodes of the upper electrode pattern are substantially the same as the shapes, the sizes, and the intervals of the plurality of electrodes of the lower electrode pattern, respectively.

15. The multi-axis input apparatus of claim 11, wherein each of the plurality of electrodes of the upper electrode pattern and the plurality of electrodes of the lower electrode pattern are formed in a structure in which the line electrode surrounds the surface electrode.

16. The multi-axis input apparatus of claim 15, wherein each of the plurality of electrodes of the upper electrode pattern and the plurality of electrodes of the lower electrode pattern are formed in a spiral structure in which the line electrode surrounds the surface electrode.

17. The multi-axis input apparatus of claim 11, wherein the elastic layer is deformed horizontally (an x-axis direction) or vertically (a y-axis direction) based on the surface of the elastic layer in accordance with the direction of the applied force or deformed in a direction (a z-axis direction) vertical to the surface of the elastic layer.

18. The multi-axis input apparatus of claim 11, wherein the elastic layer is deformed in accordance with the direction of the applied force and restored to an original shape when the applied force disappears.

19. The multi-axis input apparatus of claim 18, wherein the elastic layer includes an elastic polymer.

20. The multi-axis input apparatus of claim 11, wherein the control unit calculates the deviation between two line electrodes based on a difference between the initial capacitance between the line electrode of the upper electrode pattern and the line electrode of the lower electrode pattern corresponding thereto and capacitance between the two line electrodes after predetermined force is applied to the elastic layer and estimates the shear force depending on the calculated deviation between the two line electrodes.
